(19) United States
(12) Patent Application Publication
(10) Pub. No.: US 2023/0360497 A1
(43) Pub. Date: Nov. 9, 2023

(54) A COMPUTERIZED SYSTEM FOR ENABLING MOBILE CLIENT DEVICES TO PARTICIPATE IN DIGITALIZED GAME EVENTS

(71) Applicant: MissionTransparency AB, Malmö (SE)

(72) Inventors: Urban ROSELL, Höllviken (SE); Johan LARSSON, Malmö (SE); Anders DAHLSTRÖM, Malmö (SE); Måns DAHLSTRÖM, Lund (SE)

(73) Assignee: MissionTransparency AB, Malmö (SE)

(21) Appl. No.: 18/246,232

(22) PCT Filed: Sep. 22, 2021
(86) PCT No.: PCT/SE2021/050918

§ 371 Date: Mar. 22, 2023

(30) Foreign Application Priority Data
Sep. 23, 2020 (SE) 2051105-1

(51) Int. Cl. G07F 17/32

(52) U.S. Cl. CPC G07F 17/329; G07F 17/323; G07F 17/3218; G07F 17/3269

(57) ABSTRACT

A computerized system (100) for enabling a plurality of mobile client devices (10) to participate in near real-time in digitalized game events (50) is provided herein. The system (100) comprises a ticket handling module (20) configured to receive user selections (16) from the plurality of mobile client devices (10) being indicative of desired participation in selected digitalized game events (50) among the digitalized game events (50), and in response thereto accommodate the user selections (16) by generating tickets (32) representing participation in the selected digitalized game events (50), wherein the user selections (16) are received during a predetermined time period (tp), the predetermined time period (tp) being associated with a live time of the corresponding digitalized game event (50). The system (100) further comprises a gaming module (30) configured to retrieve the generated tickets (32) from the ticket handling module (20), and draw a winning ticket (33) for a particular digitalized game event (50) among the tickets (32) that represent participation in said particular digitalized game event (50), wherein the winning ticket (33) is drawn upon the predetermined time period (tp) having passed. The system (100) also comprises a controller module (40) configured to interface the ticket handling module (20), the gaming module (30) and the plurality of mobile client devices (10), and update the plurality of the mobile client devices (10) of the progress (52) of the digitalized game events (50), thereby enabling participation in near real-time, wherein the controller module (40) is further configured to obtain ticket information of said generated tickets (32) from the ticket handling module (32), the ticket information being indicative of one or more of current ticket quantity, current participant quantity, current total credit amount, and current chance of winning the corresponding digitalized game event (50), and enabling each one of the plurality of mobile client devices (10) to subscribe to the ticket information.

### TECHNICAL FIELD

The present invention relates to computerized systems. More specifically, the present invention relates to computerized systems for digitalizing game events. Particularly, the present invention relates to enabling mobile client devices to participate in digitalized game events. The invention also relates to associated methods.

### BACKGROUND

Game events are hosted for a wide variety of purposes, including sports, e-sports, recreational activities, company events, charities, fundraisers, concerts, raffles or for other entertainment causes. Private or public actors of different sizes, ranging from smaller non-profit organizations to larger enterprises, typically host such game events. Recent digitalization trends have made it possible for a much larger population to attend these game events via computerized systems. Such computerized systems may conduct a completely virtual game event, or a reflection of a real-world physical event. In either way, they typically involve some user engagement or interaction via e.g. a mobile device. Consequently, many actors have used the advancement in technology as an opportunity to provide users with interactive, challenging, interesting and exciting digitalized solutions to allow for a fruitful user participation experience in digitalized game events.

Computerized systems that are implementing digitalized game events reflecting physical real-world events may be implemented in different ways depending on what is trying to be achieved. For instance, in online-betting or arcade games, the purpose is to be entertained and hopefully to beat the opponents and to finish as a victor, or to generate earnings. It is therefore a part of the game to outsmart the other competitors, thus not letting the other competitors know how well you perform, what choices you make, and how it affects the game. On the contrary, some game events, such as fundraiser events, have the goal of generating as much money as possible to a specific destination by encouraging people to donate. In these cases, full transparency is desired, since it may inspire many people to join in for a greater cause.

In some online gaming settings, participants are allowed to purchase lottery tickets prior to a live draw event that is being televised or in some way broadcasted to the public. For such games, there is typically a time frame with a deadline that ends prior to the live draw, and once the deadline is due users cannot buy any further tickets. The live draw just functions as means for publically presenting the results to the participants and thus does not involve any interactivity at all. There are no options for a participant to, once the draw has been initiated, engage with the televised show other than as a viewing experience.

Other existing online gaming events are (digitalized) instant lottery games. Participating users in such games purchase tickets in which the chance to win and the total prize pool are determined beforehand, i.e. before the tickets are even purchased. In these games, all parameters relating to the total prize pool and participation quantity are static, which makes up for a predictable and unengaging gaming experience.

In the exemplary games as discussed above wherein money is used as a means to participate, a crucial aspect is to ensure that the participants are able to trust that the game is conducted in a transparent manner. Transparency is especially important in online gaming, since the participants simply cannot know what happens “under the hood”, i.e. at the computer server side. The problem is twofold considering that the participants both want to be assured that the organization hosting the game can be trusted, and that the other participating users are not cheating, embezzling, or in some way acting fraudulently.

Today's implementations of computerized systems for digitalized game events include numerous problems in this sense. Particularly, no current technical solutions can provide a fruitful user participation experience, assure full transparency in the sense of trusting other participants and/or the organization hosting the game, and at the same time bring about a charitable cause. Moreover, current solutions lack the technical provisions for providing a near real-time based update stream for all participating users, as soon as any change occurs to the game event, the participants, or the payments, etc. Additionally, it is desired to be able to receive a similar near real-time based game experience, no matter how many concurrently active games you are participating in.

In light of the observations above, the present inventors have identified problems and shortcomings in this regard. Accordingly, an object of the present invention is to overcome, or at least mitigate one or more of these problems.

### SUMMARY

It is accordingly an object of the present invention to solve, eliminate, alleviate, mitigate or reduce at least some of the problems and shortcomings referred to above.

In this disclosure, a solution to the problem outlined above is proposed. In the proposed solution, a computerized system is described.

In a first aspect of the invention, a computerized system for enabling a plurality of mobile client devices to participate in near real-time in digitalized game events is provided. The system comprises a ticket handling module configured to receive user selections from the plurality of mobile client devices being indicative of desired participation in selected digitalized game events among the digitalized game events, and in response thereto accommodate the user selections by generating tickets representing participation in the selected digitalized game events, wherein the user selections are received during a predetermined time period, the predetermined time period being associated with a live time of the corresponding digitalized game event. The computerized system further comprises a gaming module configured to retrieve the generated tickets from the ticket handling module, and draw a winning ticket for a particular digitalized game event among the tickets that represent participation in said particular digitalized game event, wherein the winning ticket is drawn upon the predetermined time period having passed. The computerized system also comprises a controller module configured to interface the ticket handling module, the gaming module and the plurality of mobile client devices, and update the plurality of the mobile client devices of the progress of the digitalized game events, thereby enabling participation in near real-time, wherein the controller module is further configured to obtain ticket information of said generated tickets from the ticket handling module, the ticket information being indicative of one or more of current ticket quantity, current participant quantity, current total credit amount, and current chance of winning the corresponding digitalized game event, and enabling each one of the plurality of mobile client devices to subscribe to the ticket information.

In advantageous embodiments of the invention, the digitalized game events reflect real-world physical events.

The technical provisions of a computerized system according to the first aspect of the invention are multiple. The user of a mobile client device may follow the live-feed and progress of a game event in real-time through the computerized system. This allows for 24 hours per day operation and participation in games all over the world without requiring physical presence. Hence, participation can be enabled both via short-range and long-range communication. This is beneficial for people that may previously not have been able to participate in game events for supporting, for instance, their local team. Furthermore, the computerized system may effectively assist organizations, particularly non-profit organizations, to generate donations through the system by being able to digitalize a traditional “50/50-lottery” of a real-world physical event without relying on betting. This is gained thanks to full transparency of the system, regarding e.g. transactional information, participation information and performance information about the digitalized game events. Advantageously, such non-profit organizations can eliminate administrative work, thus incentivizing better organizational structure both when hosting events and when performing financial closings. There is also an advantageous environmental aspect in disposal of paperwork, as provisioned by the computerized system. Further to this, the system is an excellent complement to charitable causes, since it encourages people to donate money to charity organizations while at the same time supporting their local teams and/or having an engaging, interactive and entertaining gaming experience.

Technical provisions furthermore include effective detection of fraudulent behavior. During the predetermined time period associated with the live time of the event, users may submit selections being indicative of participation. Whenever any participant makes a selection, the other participants are updated of this. As the ticket information is being indicative of e.g. current ticket quantity, current participation quantity, current total credit amount, or current chance of winning the game event, participants may accordingly, for each update (i.e. time unit), identify whenever this information deviates from a typical gaming behavior. By allowing users to subscribe to ticket information, a large variety of different types of fraudulent behavior can therefore be identified. The statistical proportions and/or circumstances of the game event and/or ticket information can give participants a fully transparent view of other participants' gaming behaviors.

As a first example, if a participant is playing a game with a large amount of other participants, and no tickets are purchased for a longer time period, this may be an indication of fraudulent behavior. It is simply not statistically trustworthy or reasonable that nothing happens for a longer time period in a game played by a large number of participants. The technical provisions of the near real-time ticket information as provided by the controller module thus enable participants to subscribe to ticket information, and thereby the participants' gaming behavior. A second example may be realized for the opposite, i.e. a statistically unnatural high activity in gaming events played by a lesser number of players. This may be an indication of someone acting fraudulently. Further examples can be realized in e.g. the ratio between current chance of winning the game and the current participant quantity, the ratio between total credit amount and current ticket quantity, the ratio between total credit amount and type of game event, and so forth.

In accordance with the first aspect, the system therefore furthermore includes a uniquely transparent client side fraud detection scheme.

In one embodiment, the controller module is configured to update the plurality of mobile client devices in response to: a digitalized game event being initiated, a ticket being purchased, a digitalized game event having ended, and/or a winning ticket being drawn.

In one embodiment, the controller module is configured to obtain gaming information of the winning ticket from the gaming module, the gaming information being indicative of which device is associated with the winning ticket and how the user of said device associated with the winning ticket chooses to manage winnings related to the winning ticket, and enable each one of the plurality of mobile client devices to subscribe to the gaming information.

In one embodiment, the computerized system is configured to enable the plurality of mobile client devices to participate in near real-time in the particular digitalized game event by determining two competing entities in the digitalized game event, and initiating at least one digitalized lottery being associated with at least one competing entity each. Participation in near real-time of the plurality of mobile client devices in the digitalized game event is allowed for the predetermined time period. During the predetermined time period, the plurality of mobile client devices may be configured to communicate user selections being indicative of desired participation in a selected digitalized lottery. In response thereto, the plurality of mobile client devices may be configured to receive tickets in said selected digitalized lottery, and subscribe to information being indicative of the progress of the digitalized game event. When the predetermined time period has passed, the computerized system may be configured to draw a winning ticket for each digitalized lottery among tickets that represent participation in the associated digitalized lottery, thereby ending the at least one digitalized lottery, and notifying mobile client device(s) associated with the winning ticket(s).

In one embodiment, the computerized system is configured to notify the mobile client device(s) associated with the winning ticket(s) by transmitting a winner confirmation.

In one embodiment, the computerized system further comprises an external data module configured to interface the controller module and provide the controller module with external event data being indicative of the progress of the digitalized game events. In response to having obtained the external event data, the controller module may be further configured to enable the plurality of the mobile client devices to subscribe to the external event data.

In one embodiment, the computerized system is configured to host two or more simultaneously active digitalized game events.

In one embodiment, the plurality of mobile client devices comprises a graphical user interface configured to present one or more views, at least one of which relates to the progress of selected digitalized game events in which the mobile client device participates. The views may be an external event statistics view, a participation statistics view, a transaction statistics view, a winner statistics view, or an admin view. The graphical user interface may further be configured to present multiple views representing said two or more simultaneously active digitalized game events.

In one embodiment, the gaming module is configured to draw a winning ticket for a particular digitalized game event among tickets that represent participation in said particular digitalized game event using a random number generator.

In a second aspect of the invention, a computer-implemented method for enabling a plurality of mobile client devices to participate in near real-time in digitalized game events is provided. The method comprises receiving user selections from the plurality of mobile client devices being indicative of desired participation in selected digitalized game events among the digitalized game events, and in response thereto accommodating the user selections by generating tickets representing participation in the selected digitalized game events, wherein the user selections are received during a predetermined time period, the predetermined time period being associated with a live time of the corresponding digitalized game event. The method further comprises retrieving the generated tickets from the ticket handling module, and drawing a winning ticket for a particular digitalized game event among the tickets that represent participation in said particular digitalized game event, wherein the winning ticket is drawn upon the predetermined time period having passed. The method further comprises interfacing the ticket handling module, the gaming module and the plurality of mobile client devices, and updating the plurality of the mobile client devices of the progress of the digitalized game events, thereby enabling participation in near real-time. The method further comprises obtaining ticket information of said generated tickets, the ticket information being indicative of one or more of current ticket quantity, current participant quantity, current total credit amount, and current chance of winning the corresponding digitalized game event. The method further comprises enabling each one of the mobile client devices to subscribe to the ticket information.

In a third aspect of the invention, a computer-implemented method for operating a mobile client device to allow its user to participate in near real-time in digitalized game events, wherein the user selections are received during a predetermined time period, the predetermined time period being associated with a live time of the corresponding digitalized game event. The method comprises receiving one or more user selections being indicative of desired participation in one or more selected digitalized game events among the digitalized game events, and communicating the one or more user selection to backend server functionality for causing purchase of one or more tickets representing participation in the selected digitalized game events. The method further comprises subscribing to information from the backend server functionality of the one or more selected digitalized game events, the information including ticket information being indicative of one or more of current ticket quantity, current participant quantity, current total credit amount, and current chance of winning the corresponding digitalized game event, thereby allowing participation in near real-time, and causing presentation of the progress in one or more views through a graphical user interface. The method further comprises, if the mobile client device is associated with a winning ticket among the one or more tickets, receiving and presenting a winner confirmation, and communicating a selection of winner distributions to the backend server functionality.

In a fourth aspect of the invention, a computer program product is provided. The computer program product performs the method according to the second aspect when the computer program code is executed by a processing device, such as a CPU.

In a fifth aspect of the invention, a computer program product is provided. The computer program product performs the method according to the third aspect when the computer program code is executed by a processing device, such as a CPU.

In further aspects of the invention, a computerized system for enabling a plurality of mobile client devices to participate in near real-time in digitalized game events is provided. The system comprises a ticket handling module configured to receive user selections from the plurality of mobile client devices being indicative of desired participation in selected digitalized game events among the digitalized game events, and in response thereto accommodate the user selections by generating tickets representing participation in the selected digitalized game events. The computerized system further comprises a gaming module configured to retrieve the generated tickets from the ticket handling module, and draw a winning ticket for a particular digitalized game event among the tickets that represent participation in said particular digitalized game event. The computerized system also comprises a controller module configured to interface the ticket handling module, the gaming module and the plurality of mobile client devices, and update the plurality of the mobile client devices of the progress of the digitalized game events, thereby enabling participation in near real-time.

In further aspects of the invention, a computer-implemented method for enabling a plurality of mobile client devices to participate in near real-time in digitalized game events is provided. The method comprises receiving user selections from the plurality of mobile client devices being indicative of desired participation in selected digitalized game events among the digitalized game events, and in response thereto accommodating the user selections by generating tickets representing participation in the selected digitalized game events. The method further comprises retrieving the generated tickets from the ticket handling module, and drawing a winning ticket for a particular digitalized game event among the tickets that represent participation in said particular digitalized game event. The method further comprises interfacing the ticket handling module, the gaming module and the plurality of mobile client devices, and updating the plurality of the mobile client devices of the progress of the digitalized game events, thereby enabling participation in near real-time.

In further aspects of the invention, a computer-implemented method for operating a mobile client device to allow its user to participate in near real-time in digitalized game events. The method comprises receiving one or more user selections being indicative of desired participation in one or more selected digitalized game events among the digitalized game events, and communicating the one or more user selection to backend server functionality for causing purchase of one or more tickets representing participation in the selected digitalized game events. The method further comprises subscribing to information from the backend server functionality being indicative of the progress of the one or more selected digitalized game events, thereby allowing participation in near real-time, and causing presentation of the progress in one or more views through a graphical user interface. The method further comprises, if the mobile client device is associated with a winning ticket among the one or more tickets, receiving and presenting a winner confirmation, and communicating a selection of winner distributions to the backend server functionality.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

A reference to an entity being “designed for” doing something in this document is intended to mean the same as the entity being “configured for”, or “intentionally adapted for” doing this very something.

Throughout the description, the digitalized game events are sometimes referred to as “game events” or “games”, and the plurality of mobile client devices may be referred to as “mobile devices” or “devices”. Additionally, the computerized system may sometimes be referred to simply as a “system”.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a schematic illustration of an embodiment of some core modules of a computerized system.

FIG. 2 is an illustration of an embodiment of a mobile client device.

FIG. 3 shows an embodiment of how some components of a computerized system communicate.

FIG. 4 is an illustration of an embodiment of a ticket handling module.

FIG. 5 is an illustration of an embodiment of a gaming module.

FIG. 6 shows an exemplifying embodiment of conducting a digitalized game event.

FIG. 7 is a schematic illustration of an embodiment of a method according to the present invention.

FIG. 8 is a schematic illustration of an embodiment of a method according to the present invention.

### DETAILED DESCRIPTION OF THE EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

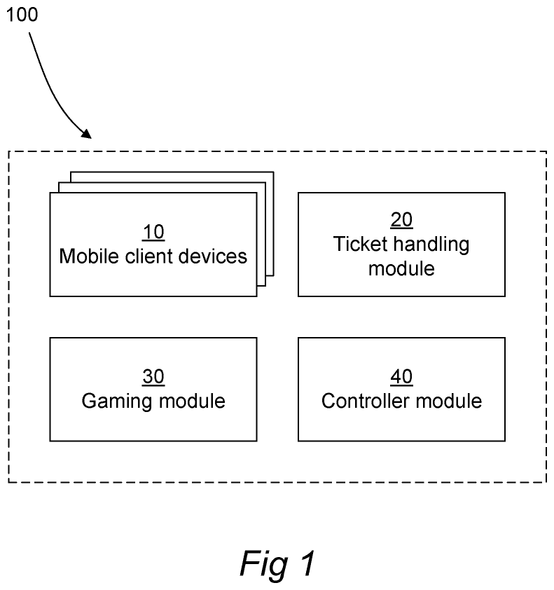

With reference to FIG. 1, one embodiment is shown of a computerized system 100 with associated components. In different settings, implementations or embodiments, the computerized system 100 may comprise fewer or any additional components than those illustrated in FIG. 1. As can be seen in FIG. 1, the system 100 comprises a plurality of mobile client devices 10, a ticket handling module 20, a gaming module 30 and a controller module 40.

In different embodiments of the invention, the components of the computerized system 100 may be implemented using instructions that enable hardware functionality, for example, by using computer program instructions executable in a general-purpose or special-purpose processor. The instructions may be stored on a computer-readable storage medium (disk, memory, etc.) to be executed by such a processor. The components are configured to read instructions from one or more computer memories and execute these instructions to control the operation of the computerized system 100. The computer memories may be implemented in any known memory technology, including but not limited to ROM, RAM, SRAM, DRAM, CMOS, FLASH, DDR, SDRAM, or some other memory technology. In some embodiments, the memories may be integrated with or be internal to the specific components of the computerized system 100.

The computerized system 100 is typically used for gaming purposes and in gaming environments. The word “gaming” in settings described throughout the description does not necessarily involve competitions, as games may be conducted or played in other settings such as for entertainment, in arcade games, recreational activities, company events, charities, fundraisers, concerts, games of chance, raffles, traditional 50/50-lotteries, and more. Gaming may also involve trying to achieve combinations of different goals by having, for instance, an overall goal of raising funds and at the same time some competition aspects in order to achieve such goal.

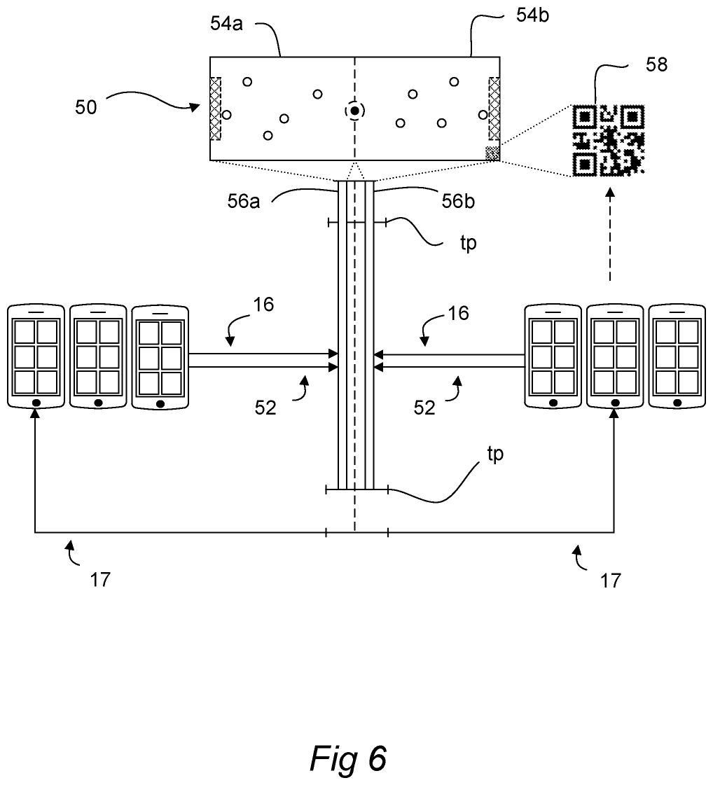

The computerized system 100 illustrated in FIG. 1 preferably enables a plurality of mobile client devices 10 to participate in digitalized game events (one exemplary game event 50 is seen in FIG. 6). Digitalized game events 50 may be reflections of real-world physical events, virtual events conducted online, or hybrids of virtual events comprising reflections of real-world physical activities. A reflection in this sense is referring to a digitalization of an event occurring live. For instance, a digitalized football game may be broken down into data identifiers representing two teams competing against each other. Updates may be given in the form of e.g. notifications representing when one of the teams scores a goal, and digitalized transaction functionalities may represent a physical real-world lottery ticket such as a 50/50-lottery ticket. A digitalized game event 50 may be, but is not limited to being, one of a sports event, recreational event, company event, raffle event, culture event, fair event or entertainment event. Participation in digitalized game events 50 is preferably enabled in near real-time, meaning that the users of the system 100 will continuously (or at least repeatedly) receive updates of the progress 52 of the digitalized game event 50. The progress 52 is related to different types of information of the digitalized game event 50, such as gaming information, ticket information, and/or external event information. This will be discussed thoroughly later on in the present disclosure. The purpose of participation in near real-time is to provide a fruitful, interactive, engaging and exciting gaming experience for the participant. In different embodiments of the invention, the participation may be enabled in near real-time, in real-time, in offline mode or batch processing, or anywhere between. This means that the user may expect some delay for the incoming updates. Of course, the gaming experience may be affected by the prevailing internet connection, and the delay of receiving updates of the progress 52 may vary. For instance, depending on a user's internet connectivity, updates may be given at any time in an arbitrary interval, ranging from immediate updates to as much as 10 seconds, or even more. The invention is by no means restricted to a specific update rate. Hereinafter, participation will be referred to as in near real-time.

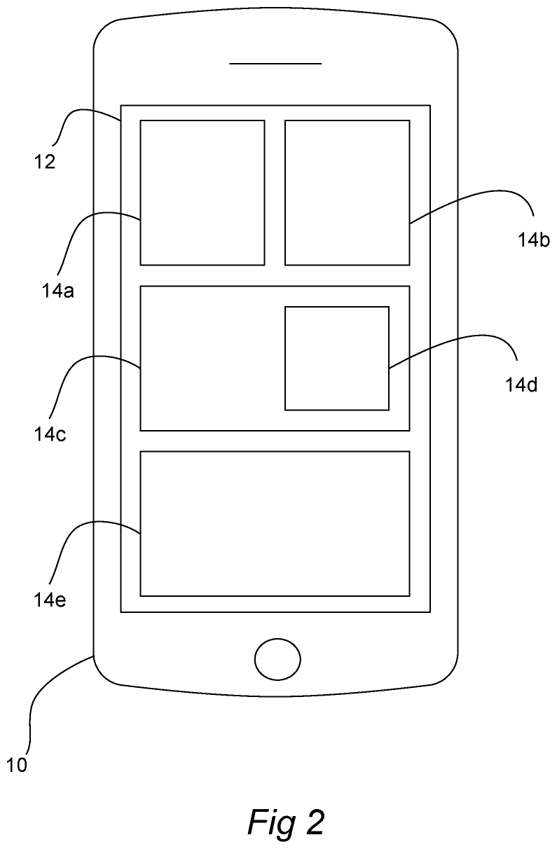

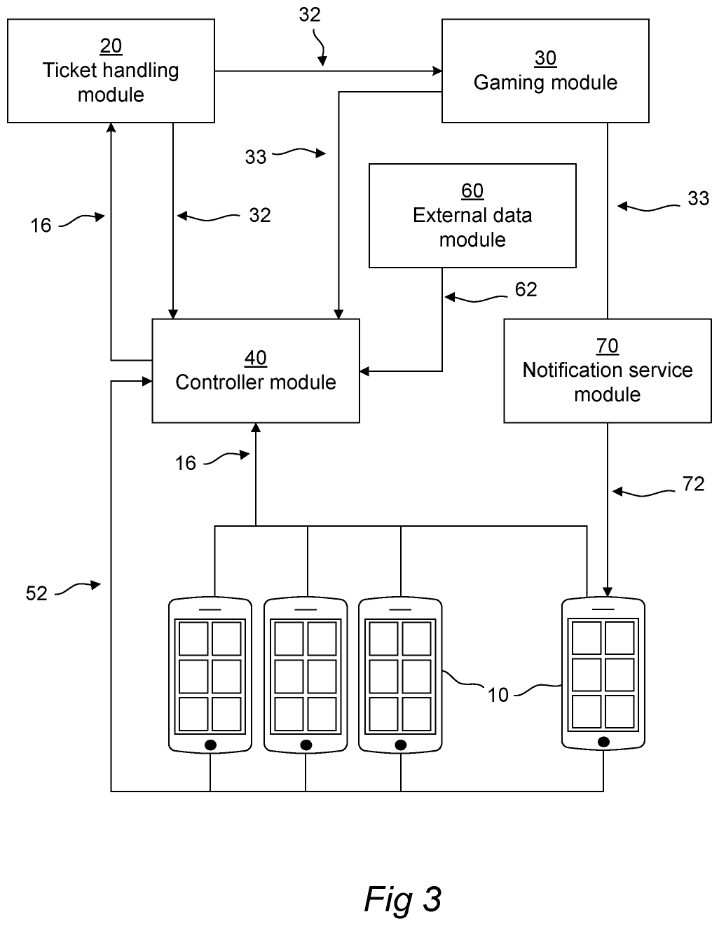

With reference to FIG. 2, the illustration shows one embodiment of a mobile client device 10. The mobile client device 10 is in this embodiment illustrated as a smart phone having a graphical user interface 12. It is, however, not restricted to being a smart phone. In different embodiments of the invention, a mobile client device 10 may be either one or a combination of tablets, portable computers, smart watches, smart bracelets, or other mobile smart devices. The mobile client device 10 is preferably operated by a user, and is configured to receive one or more user selections 16 through a graphical user interface 12 (see FIG. 3). The mobile client device 10 may also be configured to receive user selections 16 through a speech-to-text interface, via gestures captured by a camera, or other user-to-device interaction techniques. The graphical user interface 12 is configured to present one or more views 14a-e for the user of the mobile client device 10. Such views may be indicative of the progress 52 of the digitalized game event 50. Preferably, the device 10 is configured to allow the user of the device 10 to select a specific view 14 to be engaged and/or interacted with. With such an implementation, it allows the user to view arbitrary information regarding the digitalized game events 50. Hence, full transparency can be achieved for different perspectives, which will be discussed further on. The views 14a-e shown in FIG. 2 are just examples of how the views 14a-e may appear for the user, and they can preferably be adjusted to the user's preference in terms of size, dimension and location. For instance, a user only wanting to receive information from one specific view 14 can hide all others for a selected time. The views 14a-e can be any type of view relevant for a digitalized game event 50. Alternatively, the view can be a home view not related to any particular digitalized game event 50. In such a home view, the user of the mobile client device 10 may view information regarding favorite teams, leagues or competitions. Additionally, information regarding how much money that have historically been accumulated as donations to a specific team, in total and from a personal perspective, can be viewed. The home view may also comprise information regarding upcoming game events 50 associated with favorite teams, leagues or competitions.

A view 14 associated with digitalized game events 50 as shown in FIG. 2 may be an external event statistics view 14a, comprising any type of information or statistics regarding teams, competitions, leagues, matches, upcoming events, previous events, nearby events, etc. The external event statistics view 14a may for instance produce a list of nearby events based on the geolocation of the device 10, or a list of upcoming games based on user setting preferences comprising favorite teams, favorite leagues, favorite competitions, and so on. A view 14 may also be a participation statistics view 14b, comprising participation information of specific digitalized game events 50. Such participation information may comprise e.g. how the interest of a digitalized game event 50 is looking, information regarding how many users are participating in the digitalized game event 50, the gaming performance of each user, and so forth. Hence, the user can receive full participation transparency. A view 14 may also be a transaction statistics view 14c. Transaction statistics involve transactional information of a specific digitalized game event 50. The user can thus view e.g. how much money each participant has accumulated in a digitalized game event 50, how many tickets each participant currently own, or how much money a participant has previously donated to charities or collected themselves. The transaction statistics view 14c thus allows for full transactional transparency. A view 14 may also be a winner statistics view 14d comprising information regarding what happens to the money after a finished digitalized game event 50. For instance, the winner statistics view 14d may show when the winner is drawn, how the winner is drawn, who the winning participant is, how the winning money is shared, how much money is in the prize pool, etc. In some embodiments, the graphical user interface 12 is configured to present an admin view 14e so that an admin of the computerized system 100 can configure different settings related to security, integrity, or confidentiality of the participants and/or the system 100.

In one embodiment, the computerized system 100 is configured to host two or more simultaneously active digitalized game events 50. Each one of the simultaneously active digitalized game events 50 may be hosted in accordance with the teachings of the present application. Accordingly, the ticket handling module 20, the gaming module 30, and the controller module 40 may comprise functionalities for hosting a plurality of simultaneously active digitalized game events 50. Such functionalities involve implementing parallel computing schemes, parallel storage clouds for data (e.g. data including the ticket and gaming information), and comprehensible user interfaces for enabling users to view more than one game currently being participated in.

The plurality of mobile client devices 10 may submit one or more user selections 16 being indicative of participation in multiple digitalized game events 50 occurring in parallel. For instance, each mobile client device 10 may, in the associated graphical user interface 20 (e.g. such as the one shown in FIG. 2) be provided with two or more options for indicating the game event 50 in which the user desires to participate in.

The ticket handling module 20 may be configured to set up one predetermined time period tp for each corresponding digitalized game event 50. Each predetermined time period tp may be associated with a live time of the corresponding digitalized game event 50. Accordingly, the system 100 may be configured to maintain a plurality of simultaneously active predetermined time periods tp, wherein the ticket handling module 20 is configured to receive user selections 16 for each game 50 during the predetermined time period tp associated with that particular game 50. The ticket handling module 40 may thus be configured to manage a plurality of predetermined time periods tp associated with varying live times.

For each predetermined time period tp having passed, the gaming module 30 may be configured to draw a winning ticket 33. This enables a single user to win in more than one game at a time.

The controller module 40 may be configured to update the plurality of mobile client devices 10 of the progress 52 of each one of the digitalized game events 50 in which the mobile client device 10 is participating in.

In one embodiment, the graphical user interface 12 shown in FIG. 2 may be configured to present multiple views 14 representing said two or more simultaneously active digitalized game events 50. This allows for participation in near real-time in a plurality of digitalized game events 50, which provides enriched gaming experiences for the user.

In some embodiments of the invention, the plurality of mobile client devices 10 may be configured to communicate with each other via the computerized system 100. For instance, the mobile client devices 10 may be configured to receive user selections 16 indicating camera shots, live reactions through symbols, messages, etc. Alternatively, information regarding any aspect of a certain digitalized game event 50 may be shared with the plurality of the mobile client devices 10 and other devices not currently participating in the digitalized game event 50.

References are now made to FIGS. 3-5, which are illustrating flowcharts of an embodiment of the invention representing information sent between the modules and/or devices of the computerized system 100. Herein, the modules explained with reference to FIG. 1 are present, together with the addition of an external data module 60 and a notification service module 70. The embodiment shown also comprises four mobile client devices 10 that are participating in digitalized game events 50.

The mobile client devices 10 are configured to transmit one or more user selections 16 being indicative of desired participation in selected digitalized game events 50. A desired participation means that a user of one of the mobile client devices 10 has identified an interesting game event 50 that the user wants to participate in. Hence, user selections 16 comprise information indicative of selected digitalized game events 50, an identifier so that the user selections 16 are associated with a correct mobile client device 10, and some sort of credits or funds indicating that the users of the mobile client devices 10 wish to purchase tickets 32 in the selected digitalized game events 50. In some embodiments, credits or funds may not be required. The user selections 16 may indicate one or more digitalized game events 50 for desired participation. The identifier may be, but is not limited to being one of a secret key generated using any known cryptographic hash function such as SHA-1, SHA-2, CRC32 or MDS, a phone number, a social security number or any alternative identification means. The system 100 may also comprise an authentication module (not shown) being configured to authenticate the user. An authentication module may be based on technologies such as Amazon Cognito, Auth0, OAuth, Azure Active Directory, Okta, etc. The credits or funds comprised in the user selections 16 corresponds to an expected total amount in relation to a total number of tickets 32 multiplied with a unit price per ticket 32. For instance, a user of a mobile client device 10 wishes to purchase four (4) tickets in a first digitalized game event 50, and two (2) tickets in a second digitalized game event 50. Tickets 32 for the first game event 50 cost 20 credits per ticket, and 10 credits per ticket for the second game event 50. Hence, the user selections 16 in this particular example comprise a selection of the two relevant digitalized game events 50, an identifier associating the user selections 16 with the correct mobile client devices 10, and a total amount of credits corresponding to 4*20+2*10=100 credits. In an alternative embodiment, a user may select how much he or she wishes to pay for each ticket 32, wherein a minimum and/or maximum ticket price may be prompted by the system 100.

FIG. 3 further illustrates a controller module 40 configured to interface the plurality of mobile client devices 10. Upon the plurality of mobile client devices 10 having made their user selections 16, the controller module 40 is configured to route the user selections 16 from the plurality of client devices 10 to a ticket handling module 20, thereby interfacing the ticket handling module 20 as well.

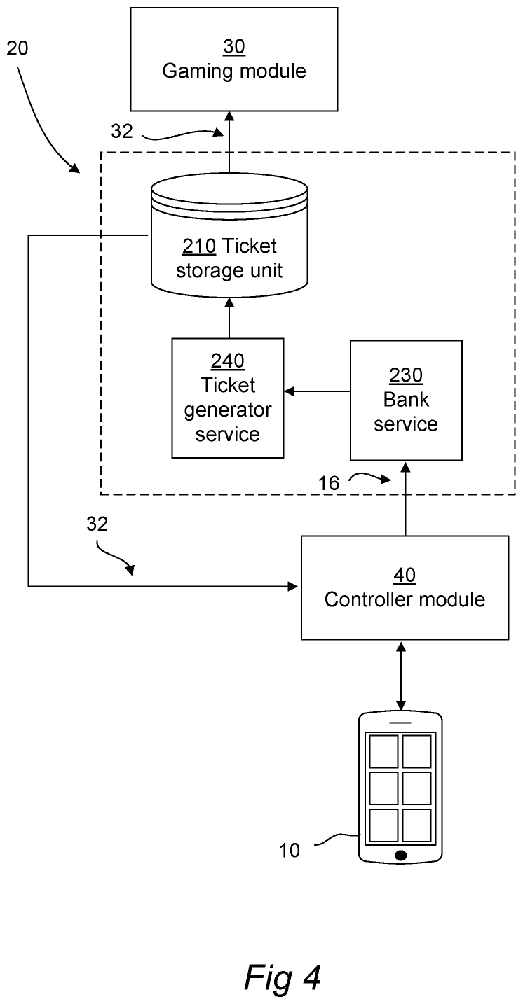

An embodiment of a ticket handling module 20 is illustrated in FIG. 4. The ticket handling module 20 shown in FIG. 4 comprises a ticket storage unit 210. The ticket storage unit 210 is preferably based on cloud-storage solutions and run on a cloud-computing platform, and connection may be established using DBaaS (Database-as-a-service). For instance, the ticket storage unit 210 may be deployed as a SQL data model such as MySQL, PostgreSQL or Oracle RDBMS. Alternatively, deployments based on NoSQL data models such as Amazon DynamoDB, MongoDB, Hadoop or Apache Cassandra may be used. DBaaS technologies include, but are not limited to Amazon Aurora, EnterpriseDB, Oracle Database Cloud Service or Google Cloud. Alternatively, the ticket storage unit 210 is maintained locally on a centralized server, or handled individually by an organization responsible for hosting digitalized game events 50. The ticket handling module 20 in FIG. 4 further comprises one or more bank services 230, and a ticket generator service 240.

In response to the ticket handling module 20 having received the user selections 16 from the mobile client devices 10, the ticket handling module 20 is further configured to accommodate the user selections 16 by generating tickets 32 representing participation in the selected digitalized game events 50 as indicated by the user selections 16. Before the tickets 32 are generated, a step of verifying the identity of the user of the mobile client device 10 may be conducted, and furthermore a step of verifying that the received credits match an expected total amount of credits. These steps may be carried out by the bank service 230. Alternatively, the authentication module (not shown) as previously described is responsible for these steps. The generated tickets 32 may subsequently be stored in the ticket storage unit 210 until a digitalized game event 50 is about to end. When tickets 32 have been generated by the ticket handling module 20, the controller module 40 is further configured to obtain ticket information of the generated tickets 32 from the ticket handling module 20. The ticket information is indicative of the progress 52 of the digitalized game event 50, in regards to participation statistics and transaction statistics. Ticket information may include, for instance, current ticket quantity, current participant quantity, current total credit amount in the prize pool, current chance of winning the game event 50, current available charity organizations, and so forth.

The controller module 40 in FIG. 3 and in other embodiments may be based on technologies suitable for real-time updating data in web and mobile applications, such as Amazon AWS AppSync, Azure Logic, IBM App Connect, WebSockets, MQTT, etc. This is particularly useful, since it enables the controller module 40 to update the plurality of the mobile client devices 10 of the progress 52 of the digitalized game events 50. Hence, participation in near real-time is enabled for the plurality of mobile client devices 10. The controller module 40 may thus be configured to update the devices 10 of the ticket information obtained from the generated tickets 32. For instance, the mobile client devices 10 may be configured to subscribe to information being indicative of the progress 52 of the digitalized game event 50 in response to a ticket 32 being purchased. As previously mentioned, the information being indicative of the progress 52 may comprise information relating to the digitalized game events 50, such as, for instance, current ticket quantity, current participant quantity, current total credit amount in the prize pool, current chance of winning the game event 50, current available charity organizations, and so forth. The controller module 40 is thus configured to enable each one of the plurality of mobile client devices 10 to subscribe to said information.

The computerized system 100 in FIG. 3 further comprises an external data module 60. The external data module 60 preferably comprises an API being configured to interface the controller module 40 and provide the controller module with external event data 62. The external event data 62 is, similar to the ticket information, indicative of the progress 52 of the digitalized game event 50. In response to having received the external event data 62, the controller module 40 may further be configured to enable the plurality of the mobile client devices 10 to subscribe to the external event data 62. These external event data 62 may comprise information relating to the digitalized game events 50, such as, for instance, when the game events 50 are initiated and/or ending, live game feed indicating when a team scores, when a penalty is given or when a player is injured, and so forth. Additionally, the external event data 62 may comprise information relating to any type of information or statistics regarding teams, competitions, leagues, matches, upcoming events, previous events, nearby events, etc. An advantage of this is that the user of the mobile client device 10 may subscribe to or actively/passively follow the live-feed information of a game event 50 in near real-time through the computerized system 10, without requiring physical presence at the game venue. This also contributes to operation 24 hours per day, and that users can participate in game events 50 all over the world having different time zones. Mobile client devices 10 can therefore participate in near real-time in digitalized game events 50 both via short-range communication standards and long-range communication standards. Short-range standards include for instance IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, or any other form of proximity-based device-to-device radio communication signal such as LTE Direct. Long-range standards include for instance W-CDMA/HSPA, GSM, UTRAN, LTE or Starlink. In one embodiment, the user of the mobile client device 50 may subscribe to the live-feed information of a game event 50 as provided by the external data module 60 before having purchased a ticket 32 in the digitalized game event 50.

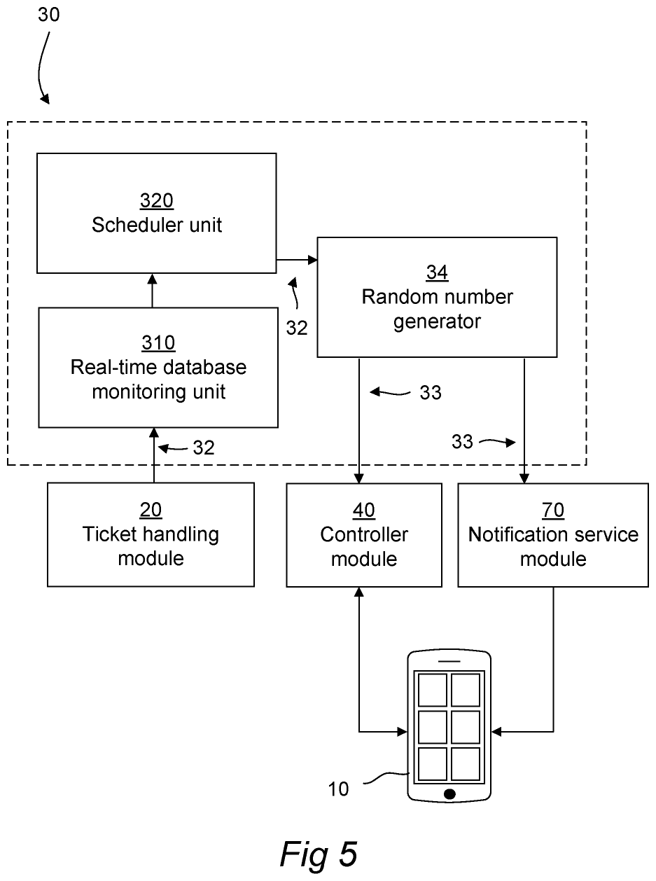

References are once again made to FIG. 3. The computerized system 100 shown in the flowchart further comprises a gaming module 30. A more detailed image of an embodiment of a gaming module 30 is shown in FIG. 5.

The gaming module 30 shown in FIG. 5 comprises a real-time database monitoring unit 310 which may be based on Amazon CloudWatch or any similar database monitoring technology. The real-time database monitoring unit 310 may monitor the ticket storage unit 210 by listening to and identifying whenever a ticket is purchased. The gaming module 30 as illustrated may further comprise a scheduler unit 320. When a particular digitalized game event 50 is ending, the scheduler unit 320 may, based on the real-time database monitoring unit 310, be configured to schedule a draw event. Once a draw event has been scheduled, the gaming module 30 is configured to draw a winning ticket 33 for the particular digitalized game event 50 among the tickets 32 that represent participation in that particular digitalized game event 50. Preferably, the winning ticket 33 is drawn using a random number generator 34, which will randomly select a winner of the digitalized game event 50. Such a random number generator 34 may be based on any general-purpose pseudorandom number generator (PRNG), such as the Marsenne Twister algorithm. The tickets 32 may be divided into sets of tickets representing different draws. For each draw, the PRNG-algorithm may generate a random 32-bit Integer value between a minimum and a maximum value. The random value may subsequently be divided by the maximum value used for the random number generation. To choose a winning ticket 33, the divided random value may be multiplied by the number of indices in a ticket array being indicative of mobile client device users and their associated amount of purchased tickets in the active draw event. Hence, a decimal winner index is obtained which is truncated into the nearest integer value. This nearest integer value will decide the winner of the draw from the ticket array. In alternative embodiments and depending on what type of digitalized game event 50 is conducted, the gaming module 30 may be configured to draw the winning ticket 33 based on different aspects such as e.g. user performance.

When the winning ticket 33 has been drawn, this information is transmitted to the plurality of mobile client devices 10. The gaming module 30 is further configured to interface the controller module 40, and the controller module 40 is further configured to obtain gaming information of the winning ticket 33 from the gaming module 30. When the gaming information has been obtained, the controller module 40 is further configured to update the plurality of mobile client devices 10 of the gaming information in response to a winning ticket 33 being drawn. The gaming information may comprise information being indicative of, for instance, which device 10 is associated with the winning ticket 33 and how the user of the device 10 associated with the winning ticket 33 chooses to manage the winnings. The skilled person may realize alternative gaming information.

Shown in FIGS. 3 and 5 are a notification service module 70. The notification service module 70 may be configured to communicate notifications 72 to the plurality of mobile client devices 10. The notifications 72 may be related to a winner confirmation 17 for the user of the mobile client device 10 associated with the winning ticket 33 to receive, so that the winnings can be distributed. Alternatively, the notification service module 70 may be configured to send notifications 72 to the mobile client devices 10 any time during digitalized game events 50, or even before or after digitalized game events 50 have been conducted. The notification service module 70 may distribute notifications 72 in response to e.g. a digitalized game event 50 is initiated or terminated. The notification service module 70 may also interface the external service module 60 and distribute notifications 72 relating to live-feed of a game event 50. Alternatively, the notification service module 70 may be configured to distribute notifications 72 of how much a specific mobile client device 10 has participated with in one game event 50, weekly, yearly or monthly. Yet alternatively, notifications 72 are related to suggestions for upcoming games or current games, which may be based on the geolocation of the mobile client device 10. Even yet alternatively, notifications 72 of information regarding favorite teams, leagues, competitions may be given.

With reference to FIG. 6, an exemplifying embodiment of a computerized system 100 configured to conduct a digitalized game event 50 is shown. The digitalized game event 50 is in this example a digitalized reflection of a physical real-world football game. For the football game, the computerized system 100 is configured to determine two competing entities 54a, 54b in the digitalized game event 50, wherein the competing entities 54 represent one team each. Hence, a significant advantage entailed with the computerized system 100 is related to the opportunity for non-profit organizations to generate donations through the system 100. The admin view 14e of the graphical user interface 12 as previously described may therefore serve as a platform for controlling generated funds to non-profit organizations through the computerized system 100.

The computerized system 100 is in this example further configured to initiate two digitalized lotteries 56a, 56b being associated with one competing entity 54 each. The system 100 may initiate one or more digitalized lotteries 56 in different embodiments. This allows for the plurality of mobile client devices 10 to participate in near real-time in one or more the digitalized lotteries 56. Hence, a favorite team may be supported. It furthermore allows for full transparency of the game, since all participating devices 10 may view the progress 52 of the digitalized game event 50 for both of the digitalized lotteries 56. The plurality of mobile client devices 10 may be configured to enter the game event 50 through one of the views 14 of the graphical user interface 12 as previously described. Alternatively, as shown in FIG. 6, the devices 10 may be configured to scan a Quick Response code (QR-code) 58 to receive all necessary game information to allow for desired participation. QR-codes 58 related to the computerized system 50 may be physically distributed at the game venue, and in response to scanning the QR-code 58, the mobile client device 10 may enter the actual digitalized game event 50, a team's respective information page, or any relevant digital location.

The computerized system 100 is further configured to allow participation in near real-time of the plurality of mobile client devices 10 in the digitalized game event 50 for a predetermined time period tp. The predetermined time period tp is determined by the system 100, and may for instance be a set time of e.g. 2 hours, or associated with the live time of the corresponding digitalized game event 50. The live time, or real live time, is the actual (real) time in which a process, such as the conduction of the digitalized game event, takes place, or an event, such as the physical game, occurs. The predetermined time period tp may be associated with the live time either exactly in time, or differing for some arbitrary time period. As an example, if the live time is 2 hours, the predetermined time period tp may be anywhere between 1 hour and 30 minutes to 2 hours and 30 minutes, or alternatively a shorter or longer time interval. The predetermined time period tp may be initiated before the live time of the corresponding digitalized game event 50, or supersede the live time of the corresponding digitalized game event 50. The predetermined time period tp may alternatively be initiated upon the live time of the game has been determined. The participants may thus be able to buy tickets for some time before the event occurs, and the predetermined time period tp is therefore associated with the live time of the corresponding digitalized game 50 event such that the initiation of the predetermined time period tp precedes the live time. For instance in the sense of a football game, the start of the predetermined time period tp and thus the live time may occur when the referee starts the live game, and the end of the predetermined time period tp may occur when the referee ends the live game. Alternative predetermined time period tp associations with the live time may be realized.

During this predetermined time period tp, the plurality of mobile client devices 10 may be configured to communicate user selections 16 being indicative of desired participation in a selected digitalized lottery 56. Accordingly, the ticket handling module 20 is configured to receive the user selections 16 during the predetermined time period tp. The predetermined time period tp may be associated with the live time of the corresponding digitalized game event 50 in accordance with the teachings herein.

When the computerized system 100 has accommodated the user selections 16, tickets 32 in the selected digitalized lottery 56 may be received. Additionally, the mobile client devices 10 are configured to subscribe to information being indicative of the progress 52 of the digitalized game events. Subscription in this sense is referring to being able to receive updates in near real-time of the progress 52 of the digitalized game events through the computerized system 100. The progress 52 involve one or more of the information as previously described. In alternative embodiments, a mobile client device 10 may be configured to subscribe to information being indicative of the progress 52 of the digitalized game event 50 even if tickets 32 have not been purchased. Hence, it may be possible to participate in near real-time as a spectator and thus receive updates without necessarily purchasing tickets 32.

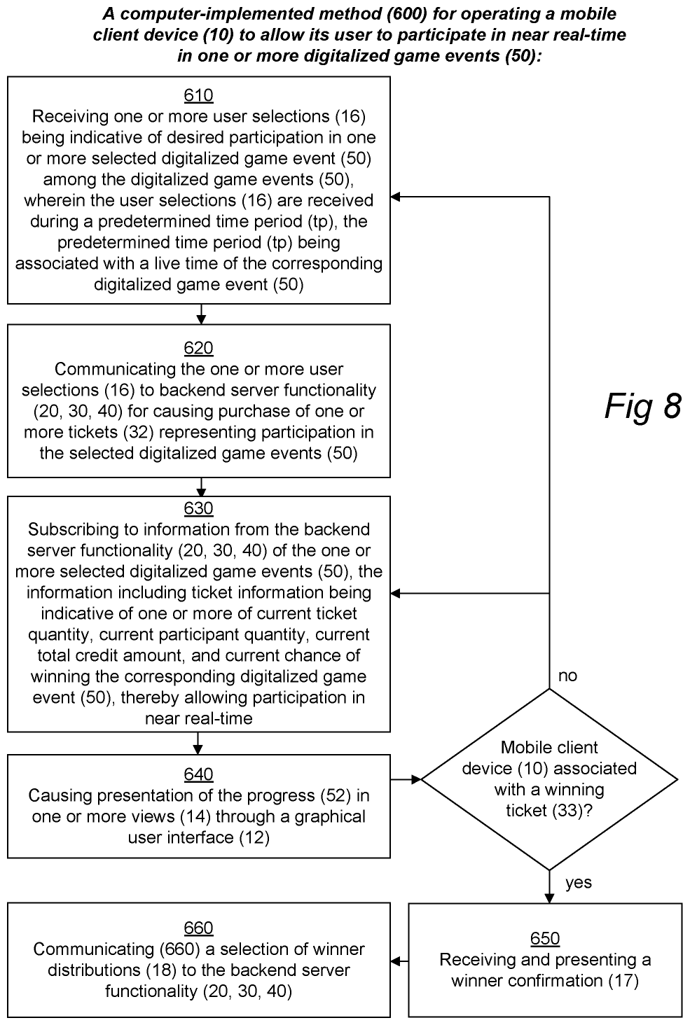

When the predetermined time period tp has passed, the computerized system 100 is further configured to draw a winning ticket 33 for each digitalized lottery 56 among tickets 32 that represent participation in the associated digitalized lottery 56. The gaming module 30 may thus be configured to draw the winning ticket 33 upon the predetermined time period tp having passed. The winning ticket 33 may alternatively be drawn in association with the live time of the corresponding digitalized game event 50 being due, which typically occurs simultaneously (but not necessarily) as the predetermined time period tp is passing. Consequently, both of the digitalized lotteries 56a, 56b in the example are ended. The system 100 is further configured to notify the mobile client device 10 associated with the winning ticket(s) 33 for each digitalized lottery 56. Preferably, the notification service module 70 is configured to transmit a notification 72 along with a winner confirmation 17. The winner confirmation 17 may be a simple “OK”-message or the like, confirming that the mobile client device 10 has been associated with the winning ticket 33 and thereby is the winner of a digitalized lottery 56. The winner confirmation 17 may also give the user an opportunity to select how to distribute the winnings. This may be done by allowing the user to select from an exhaustive list of selections 18 representing how the winnings ought to be shared. This is discussed more with reference to FIG. 8.

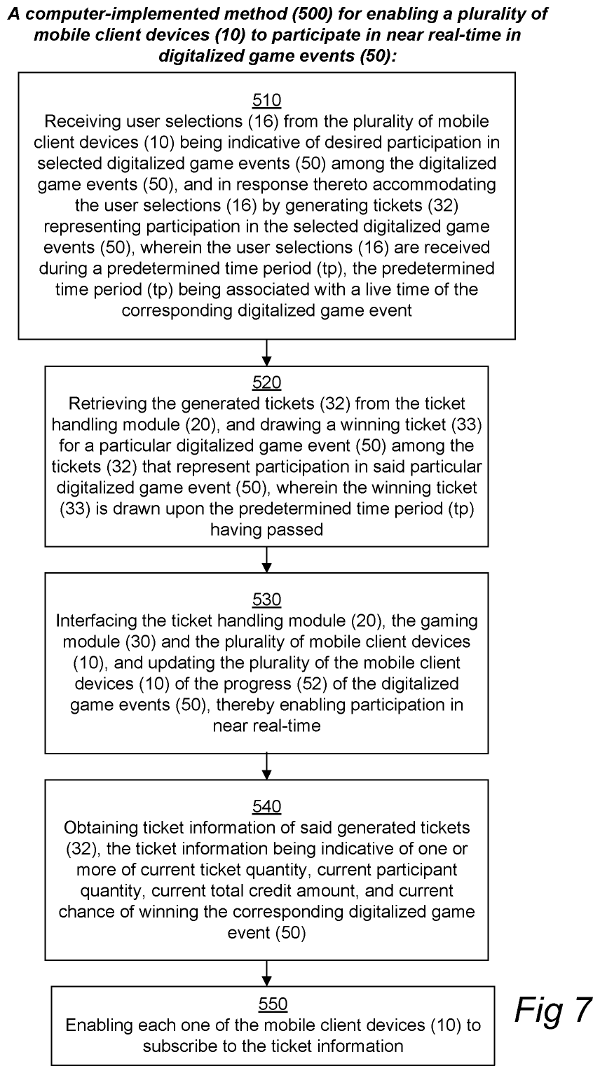

FIG. 7 illustrates an embodiment of a computer-implemented method 500 for enabling a plurality of mobile client devices 10 to participate in near real-time in digitalized game events 50. The computer-implemented method 500 is preferably implemented by backend functionality 20, 30, 40 of a computerized system 100.

The method 500 comprises a step of receiving 510 user selections 16 from the plurality of mobile client devices 10. The user selections 16 may be transmitted using any communication protocol known in the art as previously described. The user selections 16 are indicative of desired participation in selected digitalized game events 50, and in response to the ticket handling module 20 having received the user selections 16, the method 500 further involves accommodating the user selections 16. This is preferably done by generating tickets 32 representing participation in the selected digitalized game events 50. The user selections 16 are received during a predetermined time period tp, the predetermined time period tp being associated with a live time of the corresponding digitalized game event 50.

The method 500 further comprises a step of retrieving 520 the generated tickets 32 from the ticket handling module 20. The method also comprises drawing a winning ticket 33 for a particular digitalized game event 50 among the tickets 32 that represent participation in the particular digitalized game event 50, wherein the winning ticket is drawn upon the predetermined time period tp having passed.

The method 500 further comprises a step of interfacing 530 the ticket handling module 20, the gaming module 30, and the plurality of mobile client devices 10. Additionally, the method 500 comprises updating the plurality of mobile client devices 10 of the progress 52 of the digitalized game events 50, thereby enabling participation in near real-time.

The method 500 further comprises a step of obtaining 540 ticket information of said generated tickets 32. The ticket information is indicative of one or more of current ticket quantity, current participant quantity, current total credit amount, and current chance of winning the corresponding digitalized game event 50.

The method 500 further comprises a step of enabling 550 each one of the mobile client devices 10 to subscribe to the ticket information.

FIG. 8 illustrates an embodiment of a computer-implemented method 600 for operating a mobile client device 10 to allow its user to participate in near real-time in digitalized game events 50. A mobile client device 10 such as a tablet, portable computer, smart watch, smart bracelet, or other smart devices preferably implements the computer-implemented method 600.

The method 600 comprises a step of receiving 610 one or more user selections 16 being indicative of desired participation in one or more selected digitalized game events 50 among the digitalized game events 50. The user selections 16 are received during a predetermined time period tp, the predetermined time period tp being associated with a live time of the corresponding digitalized game event 50. The user of the mobile client device 10 may have a variety of selections to choose from, and the device 10 may receive the selections via e.g. a graphical user interface 12, a speech-to-text service, by scanning a QR-code 58, gesture interaction solutions, and/or similar known technologies for transmitting selections to a mobile client device 10.

The method 600 further comprises a step of communicating 620 the one or more user selections 16 to backend server functionality 20, 30, 40 for causing purchase of one or more tickets 32 representing participation in the selected digitalized game events 50. The server functionality 20, 30, 40 may be implemented as one or more server or serverless solutions using different architectural design selections commonly used in the arts, such as a Client/Server-based architecture, or Amazon AWS, Microsoft Azure, Google Cloud, etc. The user selections 16 may be sent through any known short-range or long-range communication standards as previously described. In other embodiments of the invention, the method 600 may involve direct communication between the plurality of mobile client devices 10 that have indicated desired participation in the game events 50.

The method 600 further comprises a step of subscribing 630 to information from the backend server functionality 20, 30, 40 of the one or more selected digitalized game events 50. The information being indicative of the progress 52 may comprise ticket information, gaming information and/or external event data 62 relating to updates of the digitalized game events 50 that have been selected for desired participation, or any other digitalized game events 50, both currently active and upcoming. The information being indicative of the progress 52 being subscribed to may be given so that the user can follow multiple simultaneously active game events 50. It may also involve participant information or transactional information, or other information realized by the skilled person.

The method 600 also comprises a step of causing 640 presentation of the progress 52 in one or more views 14 through a graphical user interface 12. Hence, the user of the mobile client device 10 may participate in near real-time in the digitalized game event 50. This step may proceed until a game event 50 is about to end. If the game event 50 is not ending, the user may interactively participate by purchasing tickets 32 in new or ongoing game events 50, follow live-feeds of the game event 50, and actively observe how a ticket 32 purchase affects different aspects of the digitalized game event 50. Hence, an engaging gaming experience is achieved.

When a digitalized game event 50 is ending and a mobile client device 10 has been associated with a winning ticket 33, the method 600 further comprises a step of receiving 650 a winner confirmation 17. The winner confirmation 17 may be sent from the backend server functionality 20, 30, 40 or a notification service module 70 external from or integrated in the backend server functionality 20, 30, 40. The winner confirmation 17 may comprise just one simple notification 72 that the mobile client device 10 has been associated with the winning ticket 33 and thereby is the winner of the game event 50. Such a winner confirmation 17 may involve manually or automatically agreeing to predefined settings comprising a fixed share distribution between different entities, e.g. charity organizations, the organization behind a competing entity 54 in the selected digitalized game event 50, and the winning mobile client device 10. The user may also be given a set of selections to choose from, together with the winner confirmation 17. Such a set of selections may be an exhaustive list of selections representing how the winnings ought to be shared or distributed. Herein, the user of the mobile client device 10 may manually select prize share distributions between the different entities as described above. The prize may be distributed on a percentage basis or on a basis dependent on the total amount of credits in the prize pool. For instance, the user may choose to keep 50% of the earnings, donate 30% to the organization associated with the home team of the real-world physical game event, and donate 20% to a charity organization.

The method 600 furthermore comprises a step of communicating 660 a selection of winner distributions to the backend server functionality 20, 30, 40. Consequently, the user of the mobile client device 10 has finished its participation in near real-time in the digitalized game event 50, which now has ended. The user may now provide additional user selections 16 being indicative of desired participation in other digitalized game events 50.

The invention has mainly been described above with reference to a few embodiments. However, as is readily appreciated by a person skilled in the art, other embodiments than the ones disclosed above are equally possible within the scope of the invention, as defined by the appended patent claims.

1. A computerized system for enabling a plurality of mobile client devices to participate in near real-time in digitalized game events, the system comprising:
a ticket handling module configured to receive user selections from the plurality of mobile client devices being indicative of desired participation in selected digitalized game events among the digitalized game events, and in response thereto accommodate the user selections by generating tickets representing participation in the selected digitalized game events, wherein the user selections are received during a predetermined time period (tp), the predetermined time period (tp) being associated with a live time of a corresponding digitalized game event;
a gaming module configured to retrieve the generated tickets from the ticket handling module, and draw a winning ticket for a particular digitalized game event among the tickets that represent participation in the particular digitalized game event, wherein the winning ticket is drawn upon the predetermined time period (tp) having passed; and
a controller module configured to interface the ticket handling module, the gaming module and the plurality of mobile client devices, and update the plurality of mobile client devices of the progress of the digitalized game events, thereby enabling participation in near real time;
wherein the controller module is further configured to obtain ticket information of the generated tickets from the ticket handling module, the ticket information being indicative of one or more of current ticket quantity, current participant quantity, current total credit amount, and current chance of winning a corresponding digitalized game event, and enable each one of the plurality of mobile client devices to subscribe to the ticket information.

2. The computerized system according to claim 1, wherein the digitalized game events reflect real-world physical events.

3. The computerized system according to claim 1, wherein the controller module is configured to update the plurality of mobile client devices in response to:
a digitalized game event being initiated,
a ticket being purchased,
a digitalized game event having ended, and/or
a winning ticket being drawn.

4. The computerized system according to claim 1, wherein the controller module is configured to:
obtain gaming information of the winning ticket from the gaming module, the gaming information being indicative of which device is associated with the winning ticket and how a user of the device associated with the winning ticket chooses to manage winnings related to the winning ticket, and
enable each one of the plurality of mobile client devices to subscribe to the gaming information.

5. The computerized system according to claim 1, wherein the system is configured to enable the plurality of mobile client devices to participate in near real-time in the particular digitalized game event by:
determining two competing entities in the digitalized game event,
initiating at least one digitalized lottery being associated with at least one competing entity,
allowing participation in near real-time of the plurality of mobile client devices in the digitalized game event for the predetermined time period (tp), wherein during the predetermined time period (tp), the plurality of mobile client devices are configured to:
communicate user selections being indicative of desired participation in a selected digitalized lottery, and in response thereto receive tickets in the selected digitalized lottery, and
subscribe to information being indicative of the progress of the digitalized game event,
when the predetermined time period (tp) has passed, drawing a winning ticket for each digitalized lottery among tickets that represent participation in an associated digitalized lottery, thereby ending the at least one digitalized lottery, and
notifying mobile client device(s) associated with the winning ticket(s).

6. The computerized system according to claim 5, wherein the system is further configured to notify the mobile client device(s) associated with the winning ticket(s) by transmitting a winner confirmation.

7. The computerized system according to claim 1, wherein the system further comprises an external data module configured to interface the controller module and provide the controller module with external event data being indicative of the progress of the digitalized game events, and
wherein in response to having obtained the external event data, the controller module is further configured to enable the plurality of the mobile client devices to subscribe to the external event data.

8. The computerized system according to claim 1, wherein the computerized system is configured to host two or more simultaneously active digitalized game events.

9. The computerized system according to claim 1, wherein each one of the plurality of mobile client devices comprises a graphical user interface configured to present one or more views, at least one of which relates to the progress of selected digitalized game events in which the mobile client device participates.

10. The computerized system according to claim 9, wherein the graphical user interface is further configured to present multiple views representing two or more simultaneously active digitalized game events.

11. The computerized system according to claim 1, wherein the gaming module is configured to draw the winning ticket for the particular digitalized game event among tickets that represent participation in the particular digitalized game event using a random number generator.

12. A computer-implemented methods for enabling a plurality of mobile client devices to participate in near real-time in digitalized game events, the method comprising:
receiving user selections from the plurality of mobile client devices being indicative of desired participation in selected digitalized game events among the digitalized game events, and in response thereto accommodating the user selections by generating tickets representing participation in the selected digitalized game events, wherein the user selections are received during a predetermined time period (tp), the predetermined time period (tp) being associated with a live time of corresponding digitalized game event;
retrieving the generated tickets from the ticket handling module, and drawing a winning ticket for a particular digitalized game event among the tickets that represent participation in the particular digitalized game event, wherein the winning ticket is drawn upon the predetermined time period (tp) having passed; and
interfacing the ticket handling module, the gaming module and the plurality of mobile client devices, and updating the plurality of the mobile client devices of the progress of the digitalized game events, thereby enabling participation in near real-time;
obtaining ticket information of the generated tickets, the ticket information being indicative of one or more of current ticket quantity, current participant quantity, current total credit amount, and current chance of winning a corresponding digitalized game event; and
enabling each one of the mobile client devices to subscribe to the ticket information.

13. A computer-implemented method for operating a mobile client device to allow a user to participate in near real-time in digitalized game events, the method comprising:
receiving one or more user selections being indicative of desired participation in one or more selected digitalized game events among the digitalized game events, wherein the user selections are received during a predetermined time period (tp), the predetermined time period (tp) being associated with a live time of a corresponding digitalized game event;
communicating the one or more user selections to backend server functionality for causing purchase of one or more tickets representing participation in the selected digitalized game events;
subscribing to information from the backend server functionality of the one or more selected digitalized game events, the information including ticket information being indicative of one or more of current ticket quantity, current participant quantity, current total credit amount, and current chance of winning a corresponding digitalized game event, thereby allowing participation in near real-time;
causing presentation of the progress in one or more views through a graphical user interface; and
if the mobile client device is associated with a winning ticket among the one or more tickets:
receiving and presenting a winner confirmation, and
communicating a selection of winner distributions to the backend server functionality.

14. A computer program product comprising computer code for performing the method according to claim 12 when the computer program code is executed by a processing device.

15. A computer program product comprising computer code for performing the method according to claim 13 when the computer program code is executed by a processing device.
